(19) United States
(12) Patent Application Publication
(10) Pub. No.: US 2007/0155576 A1
(43) Pub. Date: Jul. 5, 2007

(54) Differential transmission system

(76) Inventor: David Shapiro, Cary, NC (US)

Correspondence Address: WOOD AND EISENBERG, PLLC, 6911 RICHMOND HIGHWAY, SUITE 403, Alexandria, VA, 22306, US

(21) Appl. No.: 11/325,565

(22) Filed: Jan. 5, 2006

(51) Int. Cl. F16H 48/06

(52) U.S. Cl. 475/221

(57) ABSTRACT

A differential transmission system including: a first-differential; and a second-differential, wherein the first and second differentials are coupled in series such that the output of the first-differential serves as input to the second-differential. In a first embodiment, power is transmitted from the first-differential to the second-differential by means of a first first-differential output gear and a second first-differential output gear respectively coupled to a first second-differential input gear and a second second-differential input gear. In a second embodiment, power is transmitted from the first-differential to the second-differential by means of a pulley and belt system. In a third embodiment, power is transmitted from the first-differential to the second-differential by means of a sprocket and chain system.

### FIELD OF THE INVENTION

This invention relates to transmissions systems, and more particularly, to a new differential transmission system.

### BACKGROUND OF THE INVENTION

Transmission systems as used in vehicles have a propensity to be very complex and comprise a significant number of parts that together contribute to material, assembly and maintenance costs. Thus, there is a need for a transmission system that is simpler than the prior art transmission systems.

U.S. Pat. No. 5,484,344, issued Jan. 16, 1996 to Ra et al., describes a step-less automatic variable transmission with gears in a state of constant meshing which is said to be operational without the need for disengaging or changing the gears such that the rotational output power can be varied to effect a neutral, low speed, medium speed, high speed, overdrive or reverse rotation by selecting a step-less automatic speed change method or a manual speed change method, and which includes a speed change system, an overdrive system and a speed change controlling system. In the assembly of speed change system, the overdrive system and the speed change controlling system can vary with each of the systems combined to result in numerous step-less automatic variable transmissions. To affect speed changes, low speed, medium speed, overdrive, and reverse rotation brake devices are used. Also, either the manual speed change method or the automatic speed change method can be elected. The '344 transmission system is a rather complex design thus adding material, assembly and maintenance costs.

U.S. Pat. No. 6,321,613, issued Nov. 27, 2001 to Avidor, describes a variable ratio transmission for transferring torque between an input port and an output port, wherein the transmission includes two transmission shafts mounted with an angle θ between them. A first of the shafts supports a series of at least two conical gear wheels, of different sizes and having different numbers of gear teeth, in such a manner as to define a predefined range of angular motion through which each conical gear can turn relative to its shaft. The conical gear wheels together define a conical external profile at an angle e to the first axis. A sliding gear wheel, configured for driving engagement with any one of the conical gear wheels, is engaged so as to slide along, and yet rotate together with, the second transmission shaft. An actuator displaces the sliding gear wheel along the second transmission shaft parallel to the second axis between positions corresponding to selective engagement with each of the conical gears, thereby varying a drive ratio between the first and second transmission shafts. The '613 transmission system does not teach or suggest the transmission of the present invention.

U.S. Pat. No. 6,605,017, issued Aug. 12, 2003 to Comic, describes a continuously variable transmission system that includes an asymmetric differential splitter, a collecting planet carrier assembly and steering shaft with continuously variable brake mechanism to translate torque from an input shaft to an output shaft. The '017 transmission system does not teach or suggest the transmission of the present invention.

U.S. Pat. No. 4,762,022, issued Aug. 9, 1988 to Johnshoy, describes a differential drive assembly incorporates the use of two separate and essentially parallel output drive shafts, each receiving torque through separate differential gear clusters from separate spur drive gears, which receive input power, from a transmission. Each spur drive gear is attached to an input gear of a differential gear cluster and both gears are rotatably mounted on the output shaft for that gear cluster. The differential gear clusters drive the output shafts. A control gear of each differential gear cluster, which controls the output ratio of the connected gear cluster is attached to a worm and each control gear and attached worm are also rotatably mounted on the respective output shaft. The rotation of the control gears and worms is controlled by a worm gear situated between and engaged with both worms and rotatably mounted in the gear case on an axis perpendicular to the plane of the axes of the worms. The worm gear thus engaged with both worms allows rotation of the worms only when both worms rotate, and in opposite directions. The engagement of the worms with the worm gear as used in the differential drive assembly therefore provides: (1) control of the control gear of each differential gear cluster allowing transmission of torque to the axles; (2) control of balanced proportionate differentiated drive, by allowing the worms to rotate in opposite directions; and (3) control of the dissipation of torque especially, using the irreversible drive feature of worm-worm gear engagement.

Japanese Patent No. JP56127848 describes a step-less transmission of a rotational speed of output axis in response to a value of load on the output axis by a method wherein a transmission mechanism comprising a series of differential gears is coupled to a gear pump.

Japanese Patent No. JP6137384 describes a differential gear device for a vehicle to allow rotational torque to be transmitted to the other wheel even in the case of one wheel slipping, and moreover enable the smooth turning of a vehicle.

None of the above inventions and patents, taken either singly or in combination, is seen to describe the instant invention as claimed.

### SUMMARY OF THE INVENTION

A differential transmission system comprising: a first-differential; and a second-differential, wherein the first and second differentials are coupled in series such that the output of the first-differential serves as input to the second-differential. In a first embodiment, power is transmitted from the first-differential to the second-differential by means of a first first-differential output gear and a second first-differential output gear respectively coupled to a first second-differential input gear and a second second-differential input gear. In a second embodiment, power is transmitted from the first-differential to the second-differential by means of a pulley and belt system. In a third embodiment, power is transmitted from the first-differential to the second-differential by means of a sprocket and chain system.

### BRIEF DESCRIPTION OF THE DRAWINGS

FIG. 1A shows a bottom view of a differential transmission system according to the invention.

FIG. 1B shows a bottom view of a differential transmission system according to the invention.

FIG. 2 shows a differential transmission system according to the first embodiment of the present invention.

FIG. 3 shows a differential transmission system according to the second embodiment of the present invention.

FIG. 4 shows a differential transmission system according to the third embodiment of the present invention.

### DETAILED DESCRIPTION OF THE INVENTION

This invention is directed to a transmission system, and more particularly, to a new differential transmission system.

Referring to the Figures in general, the differential transmission system of the present invention is referred to generally using the numeric label “100”, and embodiments thereof represented by alpha-numeral labels such as 100a, 100b and 100c.

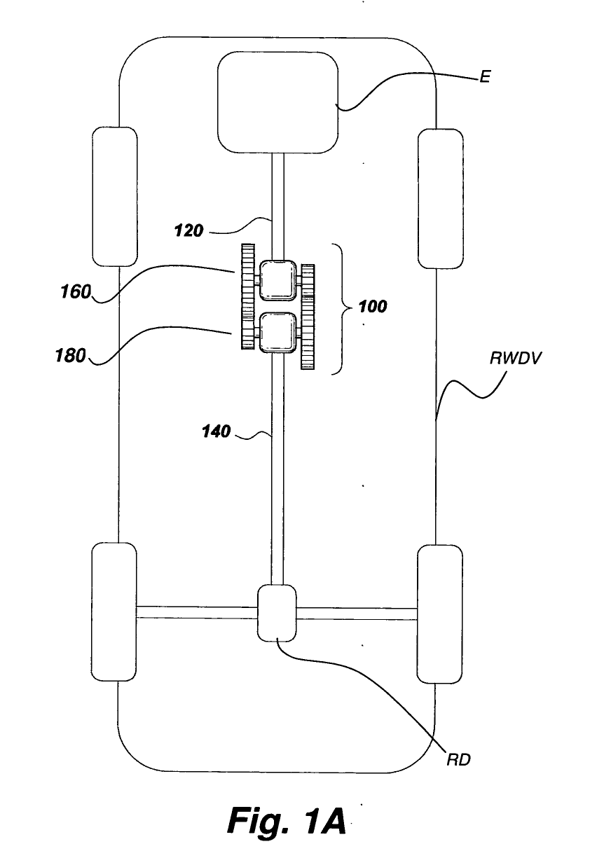

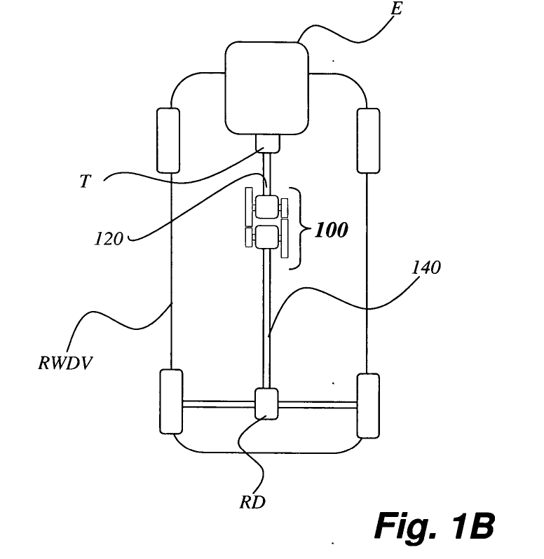

Referring to the invention in general, and FIG. 1A in particular, which shows a bottom view of a differential transmission system 100 according to the invention, which is shown connected to an input shaft (the input shaft is represented by the label “INS”) and an output shaft OS of a rear drive vehicle RWDV with a rear differential RD and powered by an engine E. The differential transmission system 100 comprises a first-differential 160 and a second-differential 180. The first-differential 160 and second-differential 180 are coupled in series such that the output of the first-differential 160 serves as input to the second-differential 180. The first-differential 160 is powered by input shaft INS, while the second-differential 180 is coupled to output shaft OS. It should be understood that the differential transmission system 100 could be fitted to various vehicles, such as tractors, trucks, automobiles with front and/or rear wheel drive, electricity generating machinery, compressors, cranes, etc.

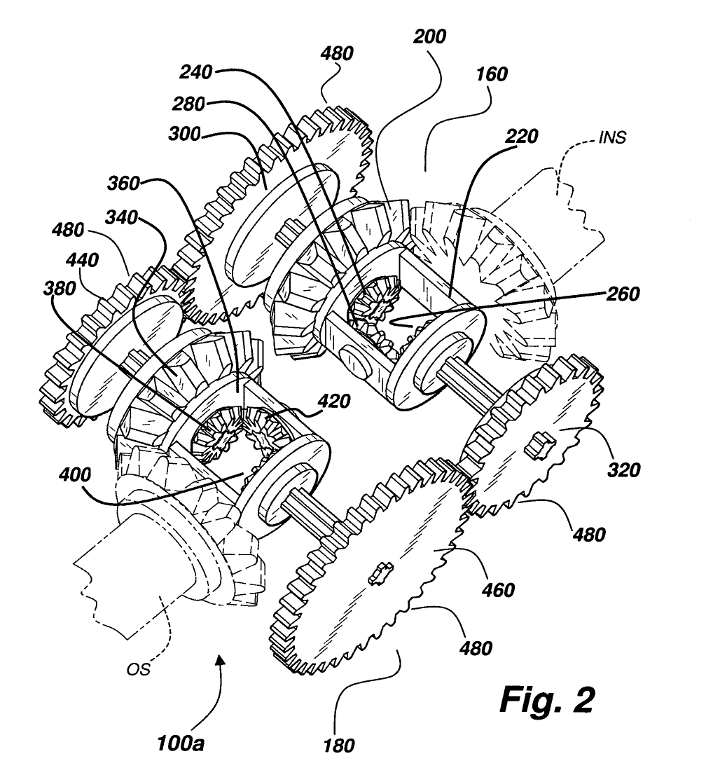

Referring to FIG. 2, which shows a first embodiment of the differential transmission system 100 of the present invention (actually represented by the alpha-numeric label “100a”). The differential transmission system 100a comprises a first-differential 160 and a second-differential 180, which are coupled in series such that the output of the first-differential 160 serves as input to the second-differential 180. The first-differential 160 comprises a first-differential ring gear 200 attached to a first-differential cage 220, a first first-differential side-gear 240, a second first-differential side-gear 260, at least one first-differential pinion-gear 280 disposed between and coupled respectively to the first and second first-differential side-gears 240 and 260, a first first-differential output gear 300, and a second first-differential output gear 320. The first and second first-differential side-gears 240 and 260 are coupled to the first and second first-differential output gears 300 and 320, respectively. The term “at least one first-differential pinion-gear 280” simply means that there can be an extra pinion gear facing opposite gear 280, and coupled to side-gears 240 and 260.

Still referring to FIG. 2, the second-differential 180 comprises a second-differential ring gear 340 attached to a second-differential cage 360, a first second-differential side-gear 380, a second second-differential side-gear 400, at least one second-differential pinion-gear 420 disposed between and coupled respectively to the first and second second-differential side-gears 380 and 400, a first second-differential input gear 440, and a second second-differential input gear 460. The first and second second-differential input gears 440 and 460 are coupled to the first and second second-differential side-gears 380 and 400, respectively. In addition, the first and second second-differential input gears 440 and 460 are coupled to the first and second first-differential output gears 300 and 320, respectively.

A plurality of teeth 480 are disposed around the circumference of each gear 300, 320, 440 and 460. The gear ratios between gears 300 and 440, and between gears 320 and 460 can vary. Thus, gear ratios can be any suitable ratio as determined on a case-by-case basis within the purview of a person of ordinary skill in the art. The gears 300 and 440, which engage each other during normal operation of the device 100, may have the same or different numbers of teeth 480. Likewise, gears 320 and 460, which engage each other during normal operation of the device 100, may have the same or different numbers of teeth 480.

Gears 300 and 460 could have the same number of teeth 480; and gears 320 and 440 can have a different number of teeth from gears 300 and 460, but share the same number of teeth 480. For example, gears 300 and 460 each have thirty teeth; and gears 320 and 440 have each have sixty teeth. In this example, gears 300 (with thirty teeth) and 440 (with sixty teeth) have a gear ratio of 1:2; and gears 320 (with sixty teeth) and 460 (with thirty teeth) have a gear ratio of 2:1.

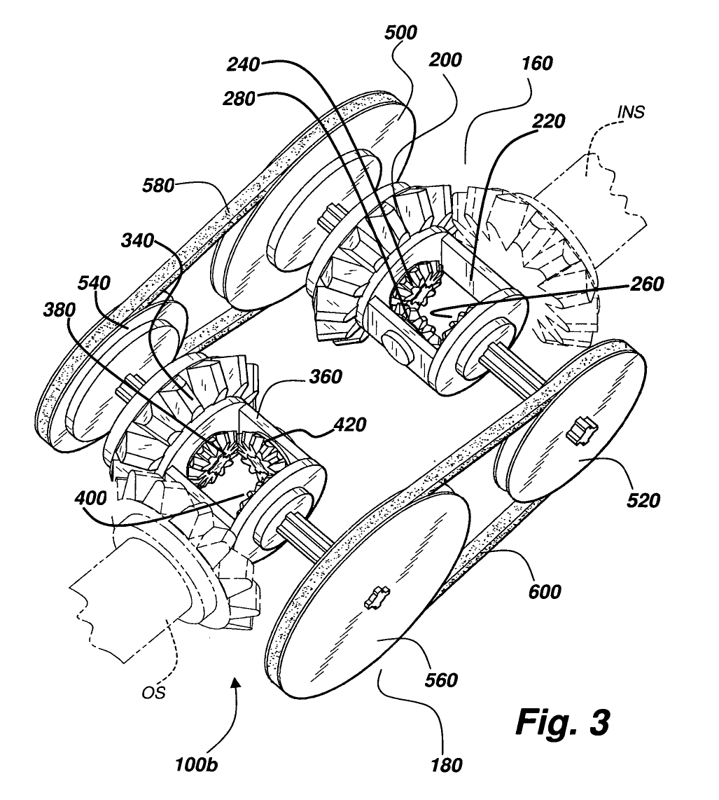

In a second embodiment, gears 300, 320, 440 and 460 are replaced with pulleys and belts. Such a device 100b is shown in FIG. 3. Specifically, first and second first-differential output gears 300 and 320 have been replaced respectively with first and second first-differential output pulleys 500 and 520; and first and second second-differential input gears 440 and 460 have been replaced respectively with first and second second-differential input pulleys 540 and 560. A first power transfer belt 580 operatively couples pulley pair 500 and 540, and a second power transfer belt 600 operatively couples pulley pair 520 and 560. More specifically, first power transfer belt 580 transfers power from the first first-differential output pulley 500 to the first second-differential input pulley 540, and the second power transfer belt 600 transfers power from the second first-differential output pulley 520 to the second second-differential input pulley 560. The use of first and second belts 580 and 600 removes the requirement of direct contact between gear teeth of two adjacent gears. In this second embodiment, gear ratios can be chosen without the engineer or designer worrying about designing direct contact between, for example, gears 300 and 440 of the first embodiment, i.e., in device 100.

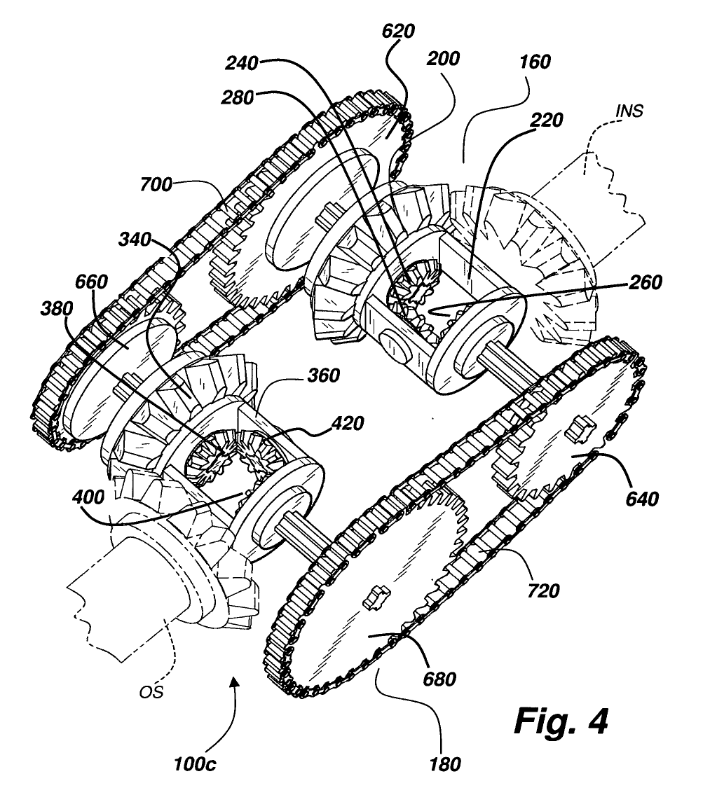

In a third embodiment, sprockets and chains are used to transfer power from the first-differential 160 to the second-differential 180. Such a device 100c is shown in FIG. 4. Specifically, device 100c has a first chain 700 that transfers power from first first-differential output sprocket 620 to first second-differential input sprocket 660, and a second chain 720 that transfers power from second first-differential output sprocket 640 to second second-differential input sprocket 680. The use of chains 700 and 720 removes the requirement of direct contact between gear teeth of two adjacent gears. In this third embodiment, gear ratios can be chosen without the engineer or designer worrying about designing direct contact between, for example, gears 300 and 440 of the first embodiment, i.e., in the first embodiment 100.

The differential transmission system of the present invention (represented by first, second and third embodiments exemplified by devices 100, 100b, and 100c) can be used in a variety of ways and scenarios. For example, the differential transmission system 100 can be used in a rear wheel drive vehicle RWDV as shown in FIG. 1A, where the differential transmission system 100 is located between an engine E and rear differential RD. The differential transmission system 100 can form part of drive train of any suitable engine driven vehicle including, and not limited to: farm tractors, semi-trucks, SUVs and automobiles. The differential transmission system 100 can also be located between the engine and front differential of a front wheel drive vehicle. The differential transmission system 100 can also be located between a traditional transmission T and rear differential RD as shown in FIG. 1B.

The differential transmission system 100, 100b or 100c, with its coupled first and second differentials 160 and 180, allows power to be transferred constantly without gear shifts or disengaging any part, e.g., there is no clutch mechanism that would otherwise have to be employed during gear changes in manual transmission systems. The differential transmission system 100, 100b or 100c enables the engine E to operate more efficiently. Since the differential transmission system 100, 100b or 100c comprises few moving parts compared with traditional transmission systems, there are fewer things to go wrong resulting in high reliability and low maintenance costs and downtime. If used with a transmission T (see FIG. 1B), the differential transmission system 100, 100b or 100c reduces the demands on the transmission T. It should be understood that the engine E can vary. For example, engine E could be an engine in an air compressor power unit or in an electricity generator, etc.

The invention has been described herein with reference to particular exemplary embodiments. Certain alterations and modifications may be apparent to those skilled in the art, without departing from the scope of the invention. The exemplary embodiments described above are meant to be illustrative, and not limiting of the scope of the invention.

I claim:

1. A differential transmission system comprising:
a first-differential; and
a second-differential, wherein said first-differential and second-differential are coupled in series such that the output of said first-differential serves as input to said second-differential.

2. The differential transmission system of claim 1, wherein power is transmitted from said first-differential to said second-differential by means of a first first-differential output gear and a second first-differential output gear respectively coupled to a first second-differential input gear and a second second-differential input gear.

3. The differential transmission system of claim 1, wherein power is transmitted from said first-differential to said second-differential by means of a first first-differential output pulley and a second first-differential output pulley respectively coupled to a first second-differential input pulley and a second second-differential input pulley, wherein a first power transfer belt transfers power between said first first-differential output pulley and said first second-differential input pulley, and wherein a second power transfer belt transfers power between said second first-differential output pulley and said second second-differential input pulley.

4. The differential transmission system of claim 1, wherein power is transmitted from said first-differential to said second-differential by means of a first first-differential output sprocket and a second first-differential output sprocket respectively coupled to a first second-differential input sprocket and a second second-differential input sprocket, wherein a first chain transfers power between said first first-differential output sprocket and said first second-differential input sprocket, and wherein a second chain transfers power between said second first-differential output sprocket and said second second-differential input sprocket.

5. A differential transmission system 100a, comprising:
a first-differential 160 and a second differential 180, wherein said first-differential 160 and second-differential 180 are in series such that the output from said first differential 160 serves as the input to said second-differential 180,
wherein said first-differential 160 comprises:
a first-differential cage 220,
a first-differential ring-gear 200, wherein said first-differential ring-gear 200 is coupled to said first-differential cage 220,
a first first-differential side-gear 240 and a second first-differential side-gear 260 with at least one first-differential pinion-gear 280 disposed between said first 240 and second 260 first-differential side-gears such that said at least one first-differential pinion-gear 280 is coupled to both said first and second first-differential side-gears 240 and 260, and wherein said at least one first-differential pinion-gear 280 is coupled to said first-differential cage 220, and
a first first-differential output gear 300 and a second first-differential output gear 320, wherein said first and second first-differential output gears 300 and 320 are respectively coupled to said first and second first-differential side gears 240 and 260,
wherein said second-differential comprises:
a second-differential cage 360,
a second-differential ring-gear 340, wherein said second-differential ring-gear 340 is coupled to said second-differential cage 360,
a first second-differential side-gear 380 and a second second-differential side-gear 400 with at least one second-differential pinion-gear 420 disposed between said first and second second-differential side-gears 380 and 400, such that said at least one second-differential pinion-gear 420 is coupled to both said first and second second-differential side-gears 380 and 400, and wherein said at least one second-differential pinion-gear 420 is coupled to said second-differential cage 360, and
a first second-differential input gear 440 and a second second-differential input gear 460, wherein said first and second second-differential input gears 440 and 460 are respectively coupled to said first and second second-differential side gears 380 and 400, and further wherein said first and second second-differential input gears 440 and 460 are respectively driven by said first and second first-differential output gears 300 and 320.

6. A differential transmission system 100b, comprising:
a first-differential 160 and a second differential 180, wherein said first-differential 160 and second-differential 180 are in series such that the output from said first differential 160 serves as the input to said second-differential 180,
wherein said first-differential 160 comprises:
a first-differential cage 220,
a first-differential ring-gear 200, wherein said first-differential ring-gear 200 is coupled to said first-differential cage 220,
a first first-differential side-gear 240 and a second first-differential side-gear 260 with at least one first-differential pinion-gear 280 disposed between said first 240 and second 260 first-differential side-gears such that said at least one first-differential pinion-gear 280 is coupled to both said first and second first-differential side-gears 240 and 260, and wherein said at least one first-differential pinion-gear 280 is coupled to said first-differential cage 220, and
a first first-differential output pulley 500 and a second first-differential output pulley 520, wherein said first and second first-differential output pulleys 500 and 520 are respectively coupled to said first and second first-differential side gears 240 and 260,
wherein said second-differential comprises:
a second-differential cage 360,
a second-differential ring-gear 340, wherein said second-differential ring-gear 340 is coupled to said second-differential cage 360,
a first second-differential side-gear 380 and a second second-differential side-gear 400 with at least one second-differential pinion-gear 420 disposed between said first and second second-differential side-gears 380 and 400, such that said at least one second-differential pinion-gear 420 is coupled to both said first and second second-differential side-gears 380 and 400, and wherein said at least one second-differential pinion-gear 420 is coupled to said second-differential cage 360, and
a first second-differential input pulley 540 and a second second-differential input pulley 560, wherein said first and second second-differential input pulleys 540 and 560 are respectively coupled to said first and second second-differential side gears 380 and 400, and further wherein said first and second second-differential input pulleys 540 and 560 are respectively driven by said first and second first-differential output pulleys 500 and 520, wherein a first power transfer belt 580 transfers power from said first first-differential output pulley 500 to said first second-differential input pulley 540, and wherein a second power transfer belt 600 transfers power from said second first-differential output pulley 520 to said second second-differential input pulley 560.

7. A differential transmission system 100c, comprising:
a first-differential 160 and a second differential 180, wherein said first-differential 160 and second-differential 180 are in series such that the output from said first differential 160 serves as the input to said second-differential 180,
wherein said first-differential 160 comprises:
a first-differential cage 220,
a first-differential ring-gear 200, wherein said first-differential ring-gear 200 is coupled to said first-differential cage 220,
a first first-differential side-gear 240 and a second first-differential side-gear 260 with at least one first-differential pinion-gear 280 disposed between said first 240 and second 260 first-differential side-gears such that said at least one first-differential pinion-gear 280 is coupled to both said first and second first-differential side-gears 240 and 260, and wherein said at least one first-differential pinion-gear 280 is coupled to said first-differential cage 220, and
a first first-differential output sprocket 620 and a second first-differential output sprocket 640, wherein said first and second first-differential output sprockets 620 and 640 are respectively coupled to said first and second first-differential side gears 240 and 260,
wherein said second-differential comprises:
a second-differential cage 360,
a second-differential ring-gear 340, wherein said second-differential ring-gear 340 is coupled to said second-differential cage 360,
a first second-differential side-gear 380 and a second second-differential side-gear 400 with at least one second-differential pinion-gear 420 disposed between said first and second second-differential side-gears 380 and 400, such that said at least one second-differential pinion-gear 420 is coupled to both said first and second second-differential side-gears 380 and 400, and wherein said at least one second-differential pinion-gear 420 is coupled to said second-differential cage 360, and
a first second-differential input sprocket 660 and a second second-differential input sprocket 680, wherein said first and second second-differential input sprockets 660 and 680 are respectively coupled to said first and second second-differential side gears 380 and 400, and further wherein said first and second second-differential input sprockets 660 and 680 are respectively driven by said first and second first-differential output sprockets 620 and 640, wherein a first chain 700 transfers power from said first first-differential output sprocket 620 to said first second-differential input sprocket 660, and wherein a second chain 720 transfers power from said second first-differential output sprocket 640 to said second second-differential input sprocket 680.
